(19) United States
(12) Patent Application Publication
(10) Pub. No.: US 2007/0277349 A1
(43) Pub. Date: Dec. 6, 2007

(54) Portable electronic device

(76) Inventor: Kai-Cheng Yu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/751,595

(22) Filed: May 21, 2007

(30) Foreign Application Priority Data
Jun. 2, 2006 (TW) 095119650

(51) Int. Cl. E05D 11/10

(52) U.S. Cl. 16/320

(57) ABSTRACT

A portable electronic device has a body, a cover connected movably to the body, and able to move between a first position and a second position relative to the body, a first magnetic component set in the body, and a rotating unit connected to the body. When the cover leaves the second position, the first magnetic component provides a first magnetic force to the rotating unit and drives the rotating unit to rotate in a first direction to push the cover to the first position.

### BACKGROUND OF THE INVENTION

1. Field of the Invention

The present invention relates to portable electronic devices, and more particularly, the present invention is a portable electronic device with a rotatable connector that connects a body and a cover.

2. Description of the Prior Art

A portable electronic device according to the prior art comprises a body, a battery, and a cover. The battery is set in a battery cavity of the body. The cover covers an outside of the battery, and forms an outer surface of the portable electronic device together with the body. The cover and the body are typically connected by a latch and a corresponding latch hole. However, this type of connection exhibits a number of disadvantages. First, if the latch clasps the latch hole too tightly, although a connection between the body and the cover is stronger, the latch will be hard to unlatch from the latch hole. On the other hand, if the latch clasps the latch hole too loosely, even though the latch is easier to unlatch from the latch hole, the cover and the body may be separated unintentionally.

### SUMMARY OF THE INVENTION

According to the present invention, a portable electronic device comprises a body, a cover connected movably to the body, and a rotating unit connected to the body. The rotating unit comprises a first component and a second component. The second component rotates the cover to a first position when the rotating unit rotates in a first direction, and the first component rotates the cover to a second position when the rotating unit rotates in a second direction.

According to the present invention, a portable electronic device comprises a body, a cover connected movably to the body, and able to move between a first position and a second position relative to the body, a first magnetic component set in the body, and a rotating unit connected to the body. When the cover leaves the second position, the first magnetic component provides a first magnetic force to the rotating unit and drives the rotating unit to rotate in a first direction to push the cover to the first position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a portable electronic device according to a first embodiment of the present invention.

FIGS. 2-5 are cross-sectional diagrams of the portable electronic device in FIG. 1.

FIG. 6 is a diagram of an actuator mechanism of a portable electronic device according to a second embodiment of the present invention.

### DETAILED DESCRIPTION

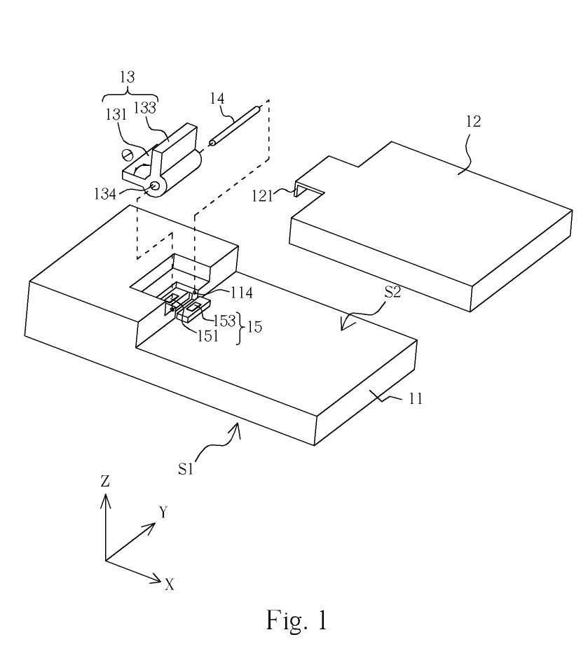

Please refer to FIG. 1, which is an exploded diagram of a portable electronic device, such as a mobile phone. The portable electronic device comprises a body 11, a display (not shown), a cover 12, a rotating unit 13, a shaft 14 and an actuator mechanism 15. The display is positioned on a first face S1 of the body 11, and is used for displaying information. The cover 12 is positioned on a second face S2 of the body 11, and can move along an edge of the body 11 in a direction corresponding to a first axis (X-axis as shown). The shaft 14 passes through an opening 134 of the rotator unit 13 and connects with a pivot 114 of the body 11. In this way, the rotator unit 13 can be connected in a rotating fashion to the body 11. The actuator mechanism 15 is used to drive the rotator unit 14 to rotate, thereby causing the cover 12 and the body 111 to connect or separate.

One end of the cover 12 comprises a connector portion 121. The connector portion 121 extends toward the body 11, and protrudes past the cover 12. When the cover 12 moves to a first position relative to the body 11, the connector portion 121 of the cover 12 clasps the rotator unit 13, such that the cover 12 and the body 111 are connected. When the cover 12 moves to a second position relative to the body 11, the connector portion 121 of the cover 12 releases from the rotator unit 13, such that the cover 12 is separated from the body 11.

The rotator unit 13 has a first component 131 and a second component 133, and is approximately L-shaped. Therefore, an angle θ is formed between the first component 131 and the second component 133. The angle θ is approximately 90°. Further, the shaft 14 is installed parallel to the second axis (the Y-axis as shown), meaning that the rotator unit 13 rotates around the second axis with respect to the body 11.

As shown in FIG. 1, in this embodiment, the actuator mechanism 15 comprises a first magnetic component 151 and a second magnetic component 153, which are symmetrical to the rotator unit 13, and are installed on the body 11.

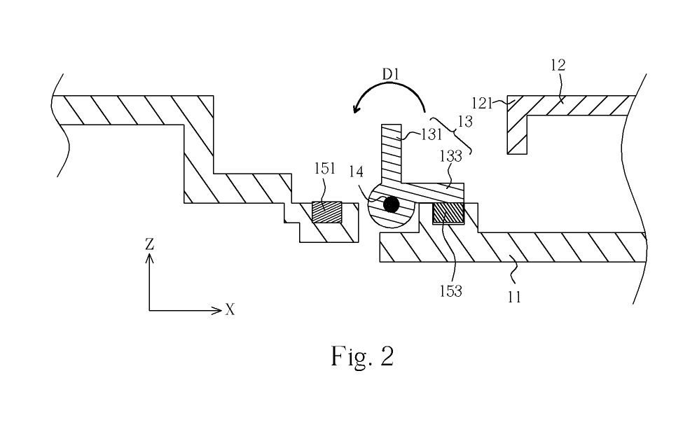

Please refer to FIGS. 2-5 for explanation of component movement in the portable electronic device of the present invention. As shown in FIG. 2, the cover 12 is at the second position, and is separated from the body 11. To connect the cover 12 to the body 11, the cover 12 can be pushed along the X-axis (in the −X direction) toward the rotator unit 13, such that the cover 12 leaves the second position. At this time, an external wall of the connector portion 121 of the cover 12 is pushed up against the first component 131 of the rotator unit 13, driving the rotator unit 13 to rotate in a first direction D1.

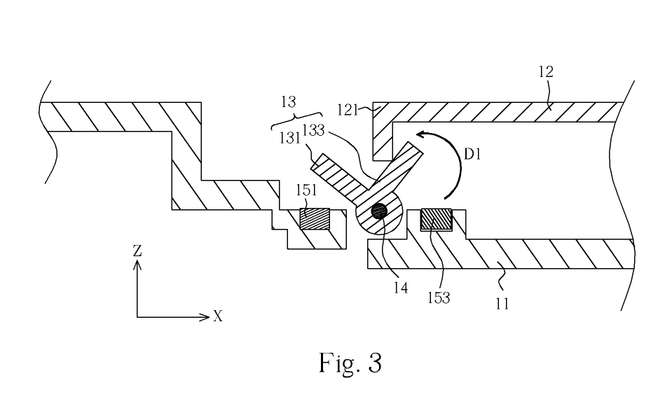

Please refer to FIG. 3. As the first component 131 of the rotator unit 13 is pushed by the cover 12 to move increasingly closer to the first magnetic component 151, the first magnetic component 151 uses a first magnetic attraction to attract the first component 131 of the rotator unit 13. Thereby, the rotator unit 13 can continue to be driven to rotate in the first direction D1. Following, the second component 133 of the rotator unit 13 pushes against an interior wall of the connector portion 121 of the cover 12 until the first component 131 sticks to the first magnetic component 151, bringing the cover 12 to the first position, connecting the cover 12 and the body 11.

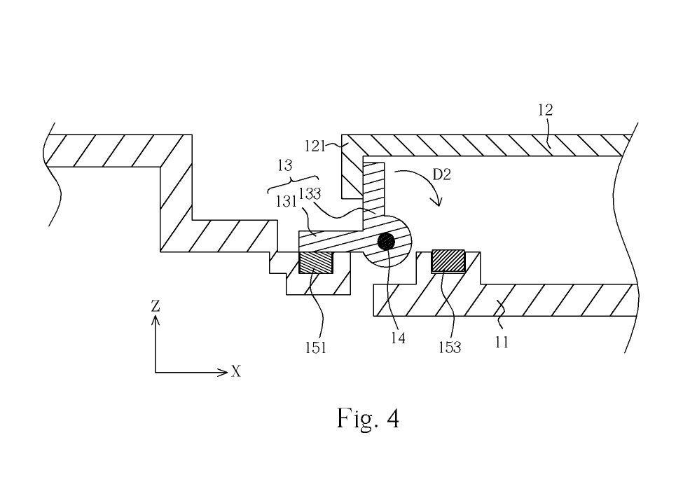

As shown in FIG. 4, at this time, the cover 12 is at the first position and connected to the body 11. Because the connector portion 121 of the cover 12 and the second component 133 of the rotator unit 13 are pushing against each other, and the first magnetic unit 151 is attracting the first component of the rotator unit 13, the cover 12 is firmly secured to the top of the body 11.

To separate the cover 12 from the body 11, the cover 12 can be pulled along the X-axis (in the +X direction) away from the rotator unit 13, such that the cover 12 leaves the first position. At this time, the interior wall of the connector portion 121 of the cover 12 pulls the second component 133 of the rotator unit 13, driving the rotator unit 13 to rotate in a second direction D2.

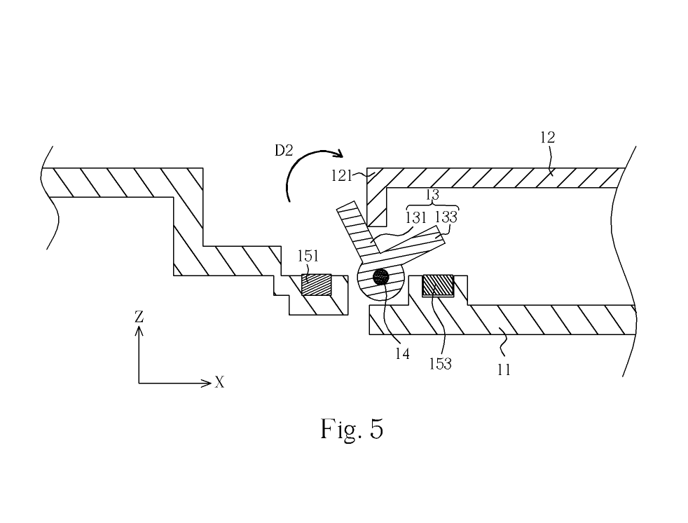

Please refer to FIG. 5. When the second component 133 of the rotator unit 13 increasingly approaches the second magnetic component 153 due to being pulled by the cover 12, the second magnetic component 153 uses a second magnetic attraction to attract the second component 133 of the rotator unit 13. Thus, the rotator unit 13 can continue to rotate in the second direction D2. Following, the first component 131 of the rotator unit 13 presses against the exterior wall of the connector portion 121 of the cover 12, until the second component 133 sticks to the second magnetic component 153, and the cover 12 reaches the second position (as shown in FIG. 2), such that the cover 12 is separated from the body 11.

In addition, when the cover 12 is separated from the body 11, the attraction between the second magnetic component 153 and the second component 133 of the rotator unit 13 makes it so that the rotator unit 13 will not rotate freely.

In the above description, the first magnetic component 151 and the second magnetic component 153 can be formed of magnets or magnetic materials. The rotator unit 13 can be formed of a metal or a magnetic material. Or, a material comprising metal or a magnetic material could be attached or spread onto a surface of the rotator unit 13. Thereby, when the rotator unit 13 rotates in the first direction D1, the first magnetic component 151 can attract the rotator unit 13 to continue rotating in the first direction D1; and, when the rotator unit 13 rotates in the second direction D2, the second magnetic component 153 can attract the rotator unit 13 to continue rotating in the second direction D2.

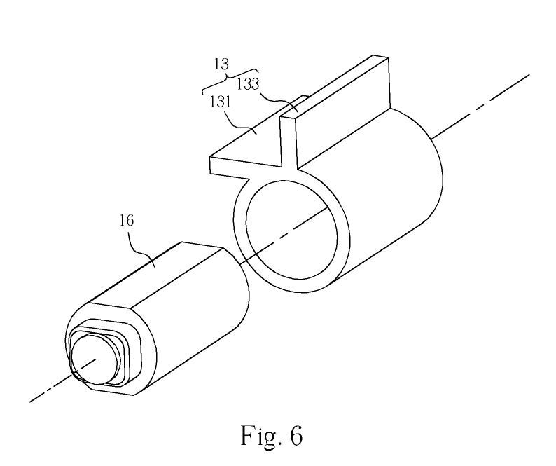

Please refer to FIG. 6 for description of a second embodiment of the portable electronic device of the present invention. In this embodiment, the actuator mechanism comprises a torque unit 16 (for example, a hinge). The torque unit 16 is installed inside the rotator unit 13, and connects the rotator unit 13 to the body 11 such that the rotator unit 13 can rotate.

Please refer now to the actuator mechanism of FIG. 6 with respect to the operation of the portable electronic device described in FIGS. 2-5. To connect the cover 12 with the body 11, the cover 12 is pushed along the X-axis (in the −X direction) toward the rotator unit 13, causing the cover 12 to leave the second position. At this time, the exterior wall of the connector portion 121 of the cover 12 pushes against the first component 131 of the rotator unit 13, thereby driving the rotator unit 13 to rotate in the first direction D1. Simultaneously, the torque unit 16 supplies a first torque to the rotator unit 13 such that the rotator unit 13 continues to rotate in the first direction D1. The second component 133 of the rotator unit 13 pushes against the interior wall of the connector portion 121 of the cover 12 until the first component 131 is pressed against the body 11. When the cover 12 reaches the first position, the cover 12 is connected to the body 11.

To separate the cover 12 from the body 11, the cover 12 is pushed along the X-axis (in the +X direction) toward the rotator unit 13, causing the cover 12 to leave the first position. At this time, the interior wall of the connector portion 121 of the cover 12 pulls against the first component 131 of the rotator unit 13, thereby driving the rotator unit 13 to rotate in the second direction D2. Simultaneously, the torque unit 16 supplies a second torque to the rotator unit 13 such that the rotator unit 13 continues to rotate in the second direction D2. The first component 131 of the rotator unit 13 pushes against the exterior wall of the connector portion 121 of the cover 12 until the second component 133 is pressed against the body 11. When the cover 12 reaches the second position, the cover 12 is separated from the body 11. In the above description, the first torque and the second torque are opposite in direction.

In summary, the present invention provides a portable electronic device that uses a rotator unit to connect and separate a cover from a body. The rotator unit provides sufficient force to hold the cover and the body together when connected, but also allows for easy separation of the cover and the body. Further, the rotator unit architecture is simple and does not break easily, thus fully overcoming the shortcomings of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable electronic device comprising:
a body;
a cover connected movably to the body; and
a rotating unit connected to the body, the rotating unit comprising:
a first component; and
a second component;
wherein, the second component rotates the cover to a first position when the rotating unit rotates in a first direction, and the first component rotates the cover to a second position when the rotating unit rotates in a second direction.

2. The portable electronic device of claim 1, wherein the first component is positioned at an angle from the second component.

3. The portable electronic device of claim 2, wherein a degree of the angle is roughly 90 degrees.

4. The portable electronic device of claim 1 further comprising an actuator for rotating the rotating unit in the first direction to push the cover to the first position when the cover leaves the second position.

5. The portable electronic device of claim 4, wherein the actuator comprises a first magnetic component set on the body for generating a first magnetic attraction that rotates the rotating unit in the second direction when the cover leaves the second position such that the second component pushes the cover to the first position.

6. The portable electronic device of claim 5, wherein the first magnetic component is a magnet.

7. The portable electronic device of claim 5, wherein the rotating unit comprises a magnetic material.

8. The portable electronic device of claim 5, wherein the rotating unit comprises a metal.

9. The portable electronic device of claim 4, wherein when the cover leaves the first position, the actuator drives the rotating unit to rotate in the second direction to push the cover to the second position.

10. The portable electronic device of claim 9, wherein the actuator comprises a second magnetic component set on the body for generating a second magnetic attraction that rotates the rotating unit in the second direction when the cover leaves the first position such that the first component pushes the cover to the second position.

11. The portable electronic device of claim 10, wherein the second magnetic element is a magnet.

12. The portable electronic device of claim 10, wherein the rotating unit comprises a magnetic material.

13. The portable electronic device of claim 10, wherein the rotating unit comprises a metal.

14. The portable electronic device of claim 9, wherein the actuator comprises a torque unit connected to the rotating unit for providing a first torque to the rotating unit to rotate the rotating unit in the first direction when leaving the second position to push the cover to the first position, and for providing a second torque to the rotating unit to rotate the rotating unit in the second direction when leaving the first position to push the cover to the second position, wherein a direction of the first torque and a direction of the second torque are opposite.

15. The portable electronic device of claim 1, wherein the cover comprises a connector protruding toward a direction of the body, wherein when the rotating unit rotates in the first direction, the second component pushes the connector to move the cover to the first position, and when the rotating unit rotates in the second direction, the first component pushes the connector to move the cover to the second position.

16. The portable electronic device of claim 15, wherein when the cover is positioned in the first position, the second component pushes the connector to connect the cover to the body.

17. A portable electronic device comprising:
a body;
a cover connected movably to the body, and able to move between a first position and a second position relative to the body;
a first magnetic component set in the body; and
a rotating unit connected to the body,
wherein when the cover leaves the second position, the first magnetic component provides a first magnetic force to the rotating unit and drives the rotating unit to rotate in a first direction to push the cover to the first position.

18. The portable electronic device of claim 17, wherein the rotating unit is approximately L-shaped.

19. The portable electronic device of claim 17, wherein when the cover is in the first position, the cover is connected to the body.

20. The portable electronic device of claim 17 further comprising:
a second magnetic component set in the body,
wherein when the cover leaves the first position, the second magnetic component provides a second magnetic force to the rotating unit and drives the rotating unit to rotate in a second direction to push the cover to the second position.

21. The portable electronic device of claim 20, wherein the cover is separated from the body when the cover is in the second position.

22. The portable electronic device of claim 20, wherein the rotating unit comprises:
a first component; and
a second component,
wherein when the rotating unit rotates in the first direction, the second component pushes the cover to the first position, and when the rotating unit rotates in the second direction, the first component pushes the cover to the second position.

23. The portable electronic device of claim 22, wherein the first component and the second component are set at an angle.

24. The portable electronic device of claim 23, wherein the angle is roughly larger than 90 degrees.

25. The portable electronic device of claim 20, wherein the first magnetic component and the second magnetic component are positioned symmetrically around the rotating unit.
